(19) United States
(12) Patent Application Publication
(10) Pub. No.: US 2016/0017702 A1
(43) Pub. Date: Jan. 21, 2016

(54) RADAR IMAGING OF BOREHOLES

(71) Applicants: Gennady Koscheev, The Woodlands, TX (US); Christopher John Morgan, Spring, TX (US)

(72) Inventors: Gennady Koscheev, The Woodlands, TX (US); Christopher John Morgan, Spring, TX (US)

(73) Assignee: Baker Hughes Incorporated, Houston, TX (US)

(21) Appl. No.: 14/336,331

(22) Filed: Jul. 21, 2014

(51) Int. Cl. E21B 47/00; E21B 47/12; G01S 7/03; G01V 3/30; G01S 13/90

(52) U.S. Cl. CPC E21B 47/0002; G01V 3/30; G01S 13/90; G01S 7/03; E21B 47/122

(57) ABSTRACT

A method of estimating a characteristic of a formation includes: disposing a radar imaging tool in a borehole; generating a high frequency radar signal by a radar transmitter, the high frequency radar signal having a frequency configured to limit penetration of the radar signal to a near-borehole region of the formation, the near-borehole region including a surface of the borehole and a region of the borehole proximate to the surface; detecting return signals reflected from the near-borehole region; generating an image of the near-borehole region based on the return signals; and estimating a characteristic of the formation based on the image.

### BACKGROUND

Understanding the characteristics of geologic formations is important for effective hydrocarbon exploration and production. For example, understanding the lithology and structure of formations, including the presence and characteristics of fractures, facilitates evaluation of formations for hydrocarbon production.

### SUMMARY

A method of estimating a characteristic of a formation includes: disposing a radar imaging tool in a borehole; generating a high frequency radar signal by a radar transmitter, the high frequency radar signal having a frequency configured to limit penetration of the radar signal to a near-borehole region of the formation, the near-borehole region including a surface of the borehole and a region of the borehole proximate to the surface; detecting return signals reflected from the near-borehole region; generating an image of the near-borehole region based on the return signals; and estimating a characteristic of the formation based on the image.

An apparatus for estimating a characteristic of a formation includes a radar imaging tool configured to be disposed in a borehole in the formation, the imaging tool including: a radar transmitter configured to generate a high frequency radar signal having a frequency configured to limit penetration of the radar signal to a near-borehole region of the formation, the near-borehole region including a surface of the borehole and a region of the borehole proximate to the surface; and a receiver configured to detect return signals reflected from the near-borehole region. The apparatus also includes a processor configured to generate an image of the near-borehole region based on the return signals, and estimate a characteristic of the formation based on the image.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts an exemplary embodiment of a system for performing energy industry operations;

FIG. 2 depicts an exemplary embodiment of a borehole imaging apparatus;

FIG. 3 depicts an alternative embodiment of the borehole imaging apparatus of FIG. 2; and

FIG. 4 is a flow chart providing an exemplary method of estimating characteristics of a formation.

### DETAILED DESCRIPTION

Apparatuses and methods for imaging and estimating characteristics of an earth formation are provided herein. An embodiment of a method of imaging a formation includes disposing a high frequency radar imaging tool in an open hole portion of a wellbore or borehole. The radar imaging tool includes one or more transmitters configured to emit high frequency radar signals in the borehole. High frequency signals have frequencies that limit penetration to a surface of the borehole, i.e., a borehole wall, or to a region of the formation proximate to the borehole surface. Exemplary frequencies include radio frequencies (RF) in the gigahertz range. In one embodiment, the radar imaging tool is a near-field imaging tool, configured to generate images using signals reflected from within a near-field of the transmitters. Return signals reflected from the borehole surface and/or the near-borehole region are detected and processed to form an image of the borehole surface. Various characteristics of the formation are estimated based on the image, such as lithology and the location, size and directional characteristics of fractures or faults.

In one embodiment, the imaging tool is a synthetic aperture radar (SAR) tool configured to emit moving radar beams or signals toward the borehole surface. The radar signals may be moved mechanically or electronically steered. For example, an array of miniaturized radar transceivers is included in the tool as a phased array, which can be steered in various directions (e.g., circumferentially, vertically and/or horizontally) to generate an image of the borehole surface and/or near field region.

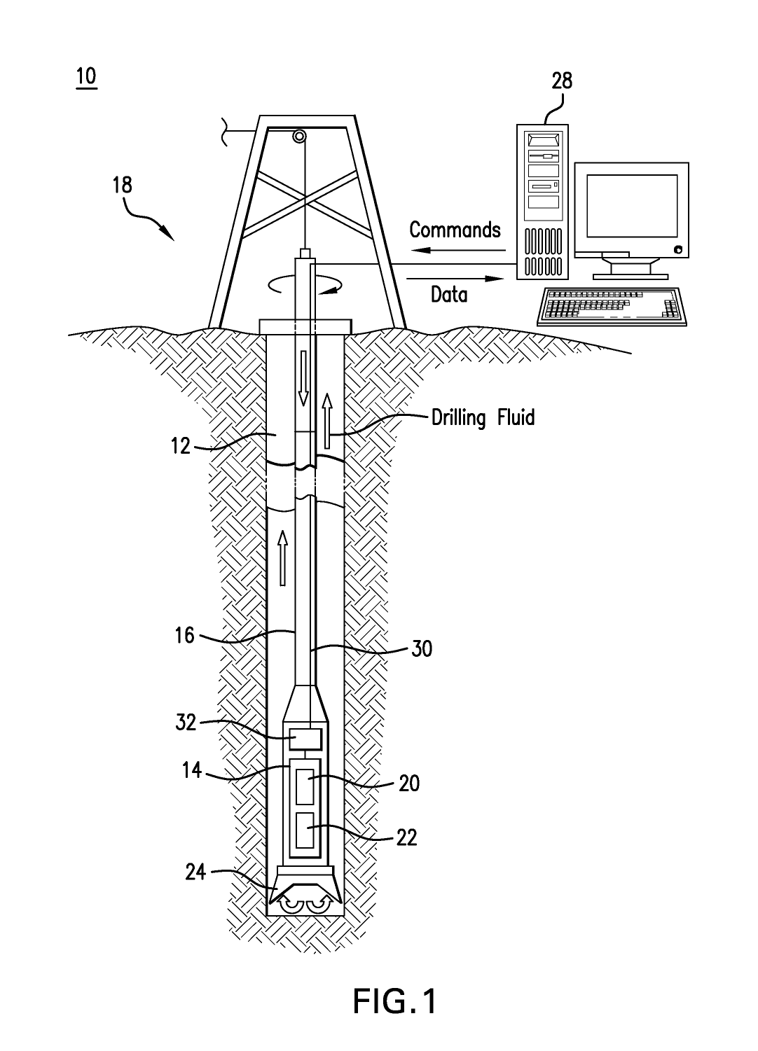

FIG. 1 illustrates an exemplary embodiment of a system for performing energy industry operations such as drilling a borehole 12, formation measurement and/or evaluation, hydrocarbon production, completion and stimulation. The system 10 includes an imaging tool 14 that is disposed in the borehole 12 and measures formation characteristics using radar measurement techniques. The tool 14 is configured to be used during a subterranean operation, such as a drilling, logging-while-drilling (LWD), fracturing or measurement (e.g., wireline) operation. The tool 14 is configured to generate radar signals that provide images of the borehole surface of a portion of the borehole 12 (also referred to as the borehole wall), and that may also provide images of an area or volume of the formation within a near-borehole region of the formation. The images may be generated for a portion that is an open hole portion or a cased portion. Such images include reflected signals from the borehole surface and/or reflected signals from the near-borehole region, i.e., a region of the formation around and proximate to the borehole surface.

The tool 14 may be configured as a component of various subterranean systems, such as well logging and LWD systems. For example, the tool 14 can be incorporated with a drill string 16 or other suitable carrier and deployed downhole, e.g., from a drilling rig 18 into the borehole 12 during a drilling operation. The tool 14 is not limited to the embodiments described herein, and may be disposed with any suitable carrier. A “carrier” as described herein means any device, device component, combination of devices, media and/or member that may be used to convey, house, support or otherwise facilitate the use of another device, device component, combination of devices, media and/or member. Exemplary non-limiting carriers include drill strings of the coiled tube type, of the jointed pipe type and any combination or portion thereof. Other carrier examples include wirelines, wireline sondes, slickline sondes, drop shots, downhole subs, bottom-hole assemblies, and drill strings.

The tool 14 includes one or more transmitters 20 configured to generate radar signals. Radar signals include electromagnetic signals typically in the radio frequency (RF) range. In one embodiment, the transmitter or transmitters 20 are configured to emit high frequency radar signals. High frequency radar signals are defined as signals having a wavelength and frequency that cause the signals to be reflected from a surface of a borehole and/or reflected from features within a near-borehole region of the formation. This is in contrast to low frequency signals, which are configured to penetrate deeper in the formation past the near field and the borehole surface. As described herein, the near-borehole region is a region of the borehole that includes the surface of the borehole or borehole wall, and may also include a surrounding volume of the formation that extends to a radial location that is proximate to the surface, e.g., less than one meter. An exemplary near-borehole region includes formation material extending from the borehole surface to a distance on the order of inches, e.g., about 1 to 1½ inches. The borehole surface may include the actual surface of the formation that is adjacent to the borehole, or an area that is located just beyond any irregularities or damage caused by a drill bit or borehole fluids. Each transmitter 20 includes a transmitting antenna connected to a controller or other suitable electronics for generating the high frequency radar signals. One or more receivers 22 are also included in the tool 14 to detect signals reflected from the borehole wall and/or near field region. In one embodiment, the transmitters 20 are configured as transceivers that can both transmit radar signals and receive reflected signals.

In one embodiment, the tool 14 is configured to image the formation in the near-borehole region using near-field imaging. Near-field imaging uses signals reflected within the near-field region of a radar antenna or transmitter. As described herein, the “near field” (or near-field) refers to a region that is defined around a transmitter, whereas the “near-borehole” region refers to a region of the formation that is defined around the borehole.

The near-field of an antenna or other transmitter is a region around the antenna in which non-radiative (reactive) behaviors and radiative behaviors occur, which is in contrast to the far field (or far-field) or “radiation zone”, in which typical electromagnetic radiation behaviors dominate. The near field can be defined as the region in which the radiation decreases with distance from the antenna (inversely proportional to distance from the antenna), whereas the far field radiation decreases with the square of the distance. In one embodiment, the near field is defined as the region that extends radially from the antenna to a distance d_{f}, referred to as the Fraunhofer distance, which is defined as:

df=2D²|λ,

where D is the length or diameter of the antenna, and λ is the wavelength generated by the antenna.

The near field region as applied to radar technology is typically an area very close to antenna, e.g., less than about two wavelengths from the transmitter.

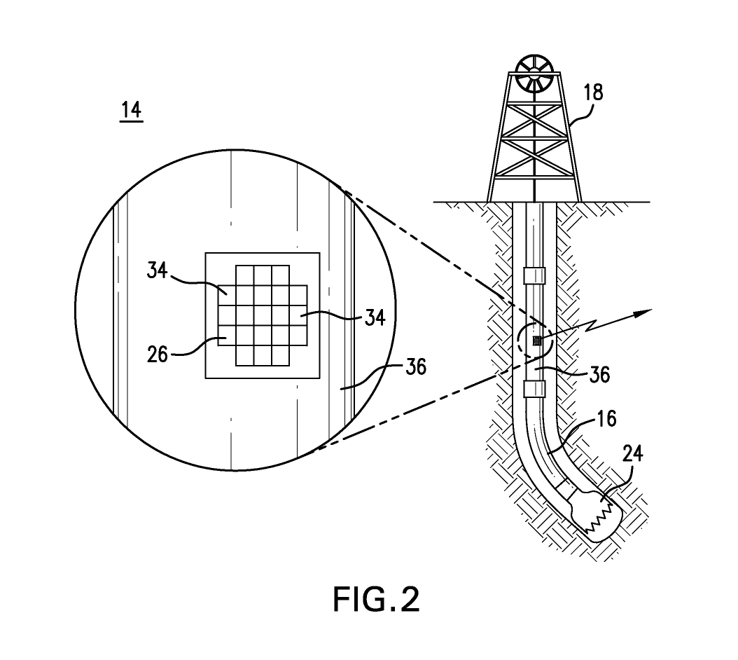

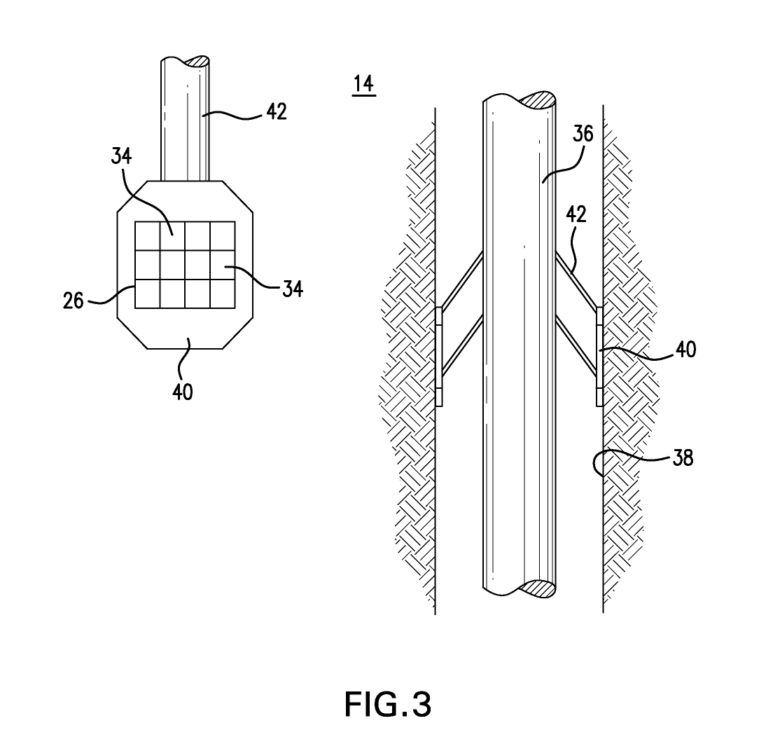

The high frequency radar signals can be moved or steered mechanically, for example, by rotating the tool 14 and/or by raising or lowering the tool 14 in the borehole 12. This may be performed during any operation. For example, the tool 14 is incorporated in the drill string 16 and is rotated with a drill bit 24 and lowered during drilling. In one embodiment, the radar signals are steered electronically using a phased array of transmitters, such as an array 26 shown in FIGS. 2 and 3. Thus, the tool 14 can be used as a real-beam radar sensor and/or as a synthetic aperture radar (SAR) sensor by moving the transmitters 20 over a target location on the borehole wall, and adding the echoes coherently.

In one embodiment, the tool 14 and/or other downhole components are equipped with transmission equipment to communicate ultimately to a surface processing unit 28. Such transmission equipment may take any desired form, and different transmission media and methods may be used, such as wired, fiber optic, and wireless transmission methods. For example, the surface processing unit 28 is connected to the transmitter(s) 20 and/or receiver(s) 22 in the tool 14 via a communication cable 30, which may include electrical conductors or optical fibers. The cable 30 can transmit command and control signals to control the frequency, timing and/or direction of the radar signals. The cable 30 may also have other functions, including transmitting data to the surface and providing power to the tool 14 and/or other components.

Additional processing units may be disposed with the carrier. For example, a downhole electronics unit 32 includes various electronic components to facilitate receiving signals and data, transmitting data, and/or processing data downhole. The surface processing unit 28, downhole electronics unit 32, the tool 14 and/or other components of the system 10 include devices as necessary to provide for storing and/or processing data collected from the tool 14 and other components of the system 10. Exemplary devices include, without limitation, at least one processor, storage, memory, input devices, output devices and the like.

Referring to FIG. 2, in one embodiment, the tool 14 includes a plurality of individual radar sensors 34. Each radar sensor includes at least one high frequency radar transmitter, and may also include at least one receiver. The plurality of radar sensors 34 may be positioned in any desired pattern or configuration. For example, the plurality of radar sensors 34 are configured as an array 26 of individual radar sensors, which are arrayed in a generally vertical direction (parallel to the tool or borehole axis), a generally horizontal direction (perpendicular to the vertical direction), or both. As shown in FIG. 2, in this embodiment, the array 26 is a generally planar array in which radar sensors 34 are arrayed in both the vertical and horizontal direction. In other embodiments, the radar sensors 34 are arrayed circumferentially, forming a full or partial ring in a plane perpendicular to the vertical direction.

The radar sensors 34 in the array are sufficiently small in size to allow a desired number of transceivers to be positioned in the tool 14. In one embodiment, each radar sensor 34 is a miniaturized component such as a microelectromechanical systems (MEMS) transceiver. Exemplary MEMS transceivers can be configured in chips or packages having dimensions of less than about one square inch (e.g., ½ inch by ½ inch), which allows for an array of a large number of radar sensors in a sufficiently small area so that the array can be incorporated into a downhole tool. Various circuit elements and components can be incorporated into a single MEMS transceiver device or module. Such components include a transmitting antenna and a receiving antenna, which may be separate components or co-located on a module, and phase shifters. In the embodiment of FIG. 2, the array 26 is disposed on or in a housing 36, such as a portion of a drill string, a pipe segment or a sonde. A window may be positioned over the array 26 for protection from downhole fluids and downhole environment conditions.

In one embodiment, as shown in FIG. 3, the array 26 (or other configuration of radar transmitters and receivers) is disposed on a structure that can be radially extended from the housing 36 to position the array 26 at a selected distance from a borehole surface, such as a borehole wall 38. For example, the tool 14 includes a pad 40 connected to extendable arms 42 that can be actuated to extend the array to be substantially in contact with the borehole wall 38. In this way, a higher frequency radar signal may be emitted, as the radar signal does not need to penetrate borehole fluids, but can be emitted directly into the formation.

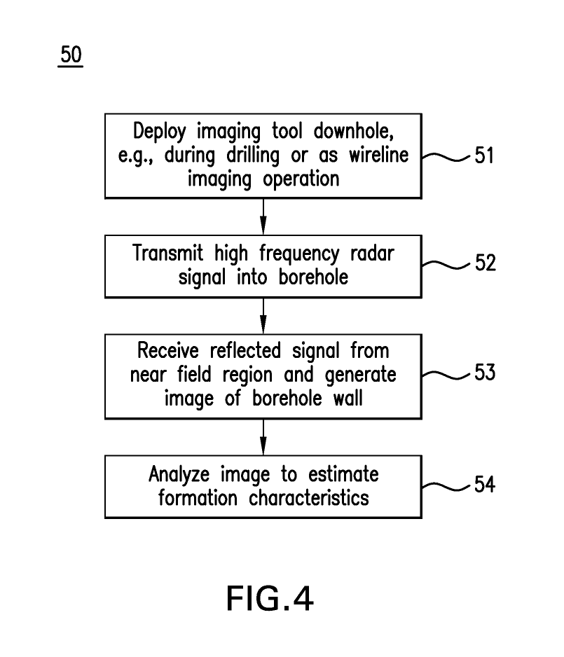

FIG. 4 illustrates a method 50 of estimating characteristics of an earth formation. The method 50 may be performed in conjunction with the system 10 and/or the tool 14, but is not limited thereto. The method 50 includes one or more stages 51-54. In one embodiment, the method 50 includes the execution of all of the stages 51-54 in the order described. However, certain stages may be omitted, stages may be added, or the order of the stages changed.

In the first stage 51, a radar imaging tool is disposed in a borehole. In one embodiment, the tool (e.g., the tool 14) is disposed during drilling as part of a LWD operation. In another embodiment, the tool 14 is deployed in an open hole portion of the borehole after drilling, e.g., during a wireline measurement operation or during a fracturing operation. The tool 14 may be deployed prior to fracturing, or prior to injecting proppant into stimulated fractures, to image natural or stimulated fractures in the formation. The method 50 is not limited to a specific type of operation, as the tool may be disposed in any suitable carrier, such as a wireline tool.

In one embodiment, the imaging tool is positioned so that the tool's transmitters, such as the array 26, are at a distance to the borehole wall that is within the near-field of the transmitters. Depending on the emitted wavelength and dimensions of the transmitting antennas, this distance may be achieved by positioning the transmitters at or near an external surface of the tool, or by extending the transmitters radially from the tool, e.g., using the pad 40.

In the second stage 52, high frequency radar signals are emitted into the borehole at selected target locations. In one embodiment, the tool 14 includes an array 26 of miniaturized transmitters or transceivers, such as MEMS transceivers, that each emit signals to locations in a target area of an open hole portion of a borehole.

For example, a two dimensional array such as the array 26 emits high frequency radar signals that reflect from the borehole surface and may penetrate into the near-borehole region of the borehole. The high frequency signals, in one embodiment, have frequencies that cause the signals to be limited to the near-borehole region, i.e., the signals do not produce reflected signals from beyond the near-borehole region that are sufficient for analysis. In one embodiment, the transmitted radar signals have a frequency that is selected so that the signals penetrate to a depth proximate to the borehole wall, in order to avoid imaging immediate damage to the formation at the wall, such as drill marks or penetration or effects on the surface by borehole fluids. Thus, the image generated may show the borehole wall or surface, or an area close to the borehole wall in the near-borehole region (e.g., up to about 1 to 1.5 inches from the wall surface).

The radar signals emitted from the tool 14 are directed to selected locations on the borehole wall by mechanically and/or electronically steering the radar beams emitted from the transmitter(s) or the array 26.

In one embodiment, each transmitter in the tool 14 is individually controllable and can be activated separately, resulting in a phased array. The timing for each transmitter or transceiver (or group thereof) in the phased array can be varied to electronically steer the radar signals. Thus, the signals can be swept without requiring physical movement of the array in the direction of the sweep.

In one embodiment, the tool 14 is moved so that the signals are mechanically steered. For example, the tool 14 is rotated, e.g., by a motor or a rotating drill string, to obtain a partial or full circumferential image. In addition, the tool 14 may be moved axially through the borehole as the signals are emitted. In one embodiment, a combination of mechanical and electronic beam steering is employed, e.g., mechanical rotation of the tool and vertical electronic beam steering are used in combination. In one embodiment, the radar signals are steered in two dimensions (e.g., vertically and horizontally/circumferentially) to generate a high resolution image of the borehole wall. The moving signals can be used as SAR signals, although the signals can be emitted as a series of stationary signals if desired.

The radar signals may be emitted at multiple frequencies so that multiple penetration depths in the near-borehole region, and beyond if desired, are obtained. A three-dimensional image of the borehole surface (or a depth proximate to the surface) and/or a volume of the near-borehole region of the formation behind the surface can thus be obtained.

In the third stage 53, near-field signals reflected from the borehole surface (and potentially in a near-borehole region of the formation) are detected by receivers in the tool 14. The reflected signals are transmitted to a processing device (e.g., downhole processing electronics 32 or the surface processing unit 28) that processes the reflected signals and generates a high resolution image of the borehole wall.

If multiple frequencies were transmitted to the borehole in order to achieve multiple penetration depths, the processor can generate a three dimensional image of the borehole wall and a volume of the formation extending radially from the wall.

In one embodiment, the processor generates SAR images from moving signals emitted from the tool 14. The moving signals may be generated by transceivers that move with the tool, for example, by axially moving and/or rotating the tool. The moving signals may also be generated by steering the emitted signals using phased array beam steering.

In the fourth stage 54, the image is analyzed to estimate formation characteristics. A user or processing device identifies irregularities shown in the borehole wall image. The irregularities are analyzed to estimate various characteristics. For example, the image can be used to identify and plot natural fractures, or stimulated fractures if the imaging was performed after fracturing. The image can be used to estimate the length, width and directional characteristics of the fracture, such as the azimuth and deviation angle of the fracture. Other characteristics that can be estimated or identified include the lithology of the formation, boundary location and direction, and lamination of rocks in the formation.

The method 50 can be performed as a periodic, near-continuous or continuous logging method. Images can be generated of any selected length by taking radar images as the tool is advanced along the borehole. In addition, the size and dimensions of each image can be controlled by controlling the number of transmitters or transceivers activated at a given location or area, and may also be controlled by moving the tool or electronically steering the radar signals. For example, a continuous 360 degree image of the borehole at a selected location can be obtained by rotating the tool and/or beam steering an array. In another example, a composite image of any selected length of the borehole can be obtained by imaging at multiple depths of the borehole. The method 50 can also be performed in real time during a drilling or logging operation.

Embodiments described herein have various advantages over prior art apparatuses and techniques. These embodiments produce high resolution images of a borehole surface and/or near-borehole region, which allows for effective identification and characterization of formation features, such as fractures, faults and boundaries. Use of higher frequency radar signals allows for a higher resolution image than is possible with prior art techniques, which typically use lower frequency radar signals in order to penetrate deeper into a formation.

In connection with the teachings herein, various analyses and/or analytical components may be used, including digital and/or analog systems. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention.

What is claimed is:

1. A method of estimating a characteristic of a formation, comprising:
disposing a radar imaging tool in a borehole;
generating a high frequency radar signal by a radar transmitter, the high frequency radar signal having a frequency configured to limit penetration of the radar signal to a near-borehole region of the formation, the near-borehole region including a surface of the borehole and a region of the borehole proximate to the surface;
detecting return signals reflected from the near-borehole region;
generating an image of the near-borehole region based on the return signals; and
estimating a characteristic of the formation based on the image.

2. The method of claim 1, wherein the radar imaging tool is a near-field radar imaging tool, and detecting return signals includes detecting radar signals reflected from within a near-field region of the radar transmitter.

3. The method of claim 2, wherein disposing the radar imaging tool includes positioning the radar transmitter at a distance from a borehole wall that is within the near-field region of the radar transmitter.

4. The method of claim 1, wherein the radar transmitter includes a phased array of radar transceivers configured to electronically steer radar signals emitted by the radar transceivers.

5. The method of claim 1, wherein the radar transmitter is a synthetic aperture radar (SAR) transmitter, and generating includes moving the radar signal within the borehole while the radar signal is transmitted into the borehole.

6. The method of claim 1, wherein the frequency is at least about one gigahertz.

7. The method of claim 6, wherein the array is disposed on at least one pad, the pad configured to extend radially from the imaging tool and be disposed proximate to the surface of the open hole portion.

8. The method of claim 1, wherein estimating includes identifying irregularities at the surface of the open hole portion and analyzing the irregularities to estimate characteristics of the formation.

9. The method of claim 8, wherein estimating includes identifying a fracture at the surface and estimating directional characteristics of the fracture.

10. The method of claim 9, wherein the directional characteristics include an azimuth and a deviation angle of the fracture.

11. An apparatus for estimating a characteristic of a formation, comprising:
a radar imaging tool configured to be disposed in a borehole in the formation, the imaging tool including:
a radar transmitter configured to generate a high frequency radar signal having a frequency configured to limit penetration of the radar signal to a near-borehole region of the formation, the near-borehole region including a surface of the borehole and a region of the borehole proximate to the surface; and
a receiver configured to detect return signals reflected from the near-borehole region; and
a processor configured to generate an image of the near-borehole region based on the return signals, and estimate a characteristic of the formation based on the image.

12. The apparatus of claim 11, wherein the radar imaging tool is a near-field radar imaging tool, and detecting return signals includes detecting radar signals reflected from within a near-field region of the radar transmitter.

13. The apparatus of claim 12, wherein the radar imaging tool is configured to be disposed so that the radar transmitter is positioned at a distance from a borehole wall that is within the near-field region of the radar transmitter.

14. The apparatus of claim 11, wherein the radar transmitter includes a phased array configured to electronically steer radar signals emitted by the radar transceivers.

15. The apparatus of claim 11, wherein the radar transmitter is a synthetic aperture radar (SAR) transmitter, and generating includes moving the radar signal within the borehole while the radar signal is transmitted into the borehole.

16. The apparatus of claim 11, wherein the frequency is at least about one gigahertz.

17. The apparatus of claim 16, wherein the array is disposed on at least one pad, the pad configured to extend radially from the imaging tool and be disposed proximate to the surface of the open hole portion.

18. The apparatus of claim 11, wherein the processor is configured to identify irregularities at the surface of the open hole portion and analyze the irregularities to estimate characteristics of the formation.

19. The apparatus of claim 18, wherein the processor is configured to identify a fracture at the surface and estimate directional characteristics of the fracture.

20. The apparatus of claim 19, wherein the directional characteristics include an azimuth and a deviation angle of the fracture.
